(19) United States
(12) Patent Application Publication
(10) Pub. No.: US 2011/0170723 A1
(43) Pub. Date: Jul. 14, 2011

(54) Earpiece headset assembly

(76) Inventor: William Ryann, San Antonio, TX (US)

(21) Appl. No.: 13/065,577

(22) Filed: Mar. 24, 2011

Related U.S. Application Data
(63) Continuation-in-part of application No. 12/384,871, filed on Apr. 9, 2009.
Application No. 12/384,871 is a continuation-in-part of application No. 11/218,860, filed on Sep. 2, 2005, now Pat. No. 7,536,150.
Application No. 11/218,860 is a continuation-in-part of application No. 11/218,391, filed on Aug. 29, 2005, now abandoned.
Application No. 11/218,391 is a continuation-in-part of application No. 11/218,392, filed on Aug. 29, 2005, now Pat. No. 7,505,793.

(51) Int. Cl. H04R 25/00; H04R 5/033

(52) U.S. Cl. 381/322; 381/376

(57) ABSTRACT

A headset assembly with a casing for ergonomic displacement to a location between a user's ear and a neckline of the user. The assembly may include an ear support for positioning a speaker at a user's ear with a user defined separation therebetween. Additionally, the casing may be displaced by two separate casing supports coupled to two separate speaker supports and speakers. Alternatively, the casing may be duplicated to allow for independent earpieces accommodating separately operable casings with electronic components disposed therein.

### PRIORITY CLAIM

This Patent Document is a Continuation-In-Part of Ser. No. 12/384,871, Wireless Earring Assembly, filed Apr. 9, 2009, which is a Continuation-In-Part of Ser. No. 11/218,860, Wireless Earring, filed Sep. 2, 2005, itself also a Continuation-In-Part of Ser. No. 11/218,391, Wireless Earpiece, filed Aug. 29, 2005 and Ser. No. 11/218,392, Wireless Earpiece Assembly, filed Aug. 29, 2005, all of which are incorporated by reference herein in their entireties.

### FIELD

Embodiments described relate to ergonomically enhanced earpiece headsets. The headsets may be configured for wirelessly coupling or pairing to an electronic device to direct audio output of the headsets. Alternatively, such headsets may be configured to amplify, transmit or otherwise improve surrounding sound for the benefit of the user, akin to a conventional hearing aid, but with enhanced ergonomics as detailed herein. Such enhanced ergonomics may be presented by way of headsets secured at the outer ear of a user or by way of an ear support positioned behind the user's ear. In the latter case, a component casing may be disposed between earpieces of the headset, which are in turn located at each ear, or independently suspended from each given earpiece (i.e. similar to earrings in appearance).

### BACKGROUND

Mobile audio devices are experiencing a dramatic growth in utilization. Such devices have evolved from transistor radios, televisions and mobile cassette players to more modern communication devices such as the mobile cell phones of today. Recently, it has become commonplace for mobile audio devices to incorporate non-audio functionality, such as cell phones or smart phones incorporating picture taking, calendaring, e-mailing, interne web browsing, and other features. Similarly, different types of mobile audio devices are beginning to merge, such as cell phones that include the capacity to play digital music.

As mobile audio devices continue to play an ever increasing role in people's lives, the importance of ergonomic utilization of such devices has also increased. For example, a headset, such as an earpiece or headphones, is often wired to a handheld mobile audio device such as a cell phone. In this manner, the cell phone need not be held right at the user's ear during operation. The wired earpiece allows the cell phone to be kept away from the user's ear without requiring use of less discrete means such as a speakerphone function. Use of a wired earpiece with the cell phone in this manner provides a degree of hands-free user-friendliness. Keeping the user's hands more free can improve safety when the user is simultaneously engaged in other tasks. For example, in many jurisdictions, hands-free use of cell phones has become required by law during operation of a motor vehicle as a matter of public safety.

In order to further address ergonomic, hands-free, and other user-friendly objectives when utilizing a mobile audio device, an earpiece may be employed in a wireless manner. For example, wireless earpieces have been conceived and developed which do not require physical wiring directly to the mobile audio device. That is, a wireless earpiece may be secured at a user's ear with a cell phone wirelessly coupled or “paired” thereto. In this manner, cumbersome wiring from the earpiece all the way to the cell phone is eliminated. The cell phone may even be somewhat remote from the user during use. For example, the driver of an automobile may be using a cell phone via a wireless earpiece while the potentially distracting cell phone easily remains away from the driver's hands or immediate vicinity.

Unfortunately, a high quality wireless earpiece must be of dramatically increased size as compared to a traditional wired mechanism. This is because, in order to provide high quality wireless capability, the wireless earpiece is equipped with a power source, microphone, transceiver, antenna, microprocessor, and potentially other electronic components, all of which are not required in a traditional wired earpiece. In a traditional wired earpiece, there is present a physically wired connection to the cell phone where such components can be maintained, distributed, or rendered unnecessary altogether. However, the nature of a wireless earpiece necessitates the inclusion of wireless and other components right at the earpiece. Thus, the earpiece often includes a large bulky casing for housing all of these components in addition to providing a speaker and other traditional wired earpiece components.

The large wireless earpiece described above is configured with a casing large enough to house the above noted components and is configured to rest over, behind, or around the back of the user's ear. It is the user's ear that is forced to bear the bulk of the entire earpiece. In total, this may include a casing having a bulk of 3 to 5 inches across and up to ¾ of an inch wide or more, all resting right at the user's ear, sandwiched between the user's ear and head, blocking the auditory canal of the user's ear, or taking some other bulky and cumbersome configuration.

Employing a wireless earpiece contributing extensive bulk at the user's ear sacrifices long term user comfort for the short term user-friendliness provided by the wireless nature of the earpiece. Extensive wear of such wireless earpieces can be quite uncomfortable, require frequent placement, replacement, and repositioning, and render the user-friendliness of wireless or ‘Bluetooth’ capacity to be of diminishing value to the user. Furthermore, attempts to redistribute the bulk resulting from such wireless earpiece components away from the user's ear to other nearby accessories to accommodate them, such as eyewear or headwear, similarly sacrifices user-friendliness. For example, the user may not require or desire wearing prescription glasses, sunglasses, hats, headphones, or other cumbersome and otherwise generally unnecessary accessories.

### SUMMARY

An earpiece headset assembly is provided that includes an ear support with a portion for positioning a speaker at a user's ear. A casing is also provided that is coupled to the ear support via a casing support. The casing is of a bulk for accommodating multiple electronic components of the assembly. The casing support, in turn serves to displace this bulk to a location between the user's ear and a neckline of the user.

### BRIEF DESCRIPTION OF THE DRAWINGS

FIG. 1 is a side view of an embodiment of an earpiece headset assembly worn by a user.

FIG. 2 is a front view of the user of FIG. 1 wearing the earpiece headset assembly thereof.

FIG. 3 is a perspective view of the assembly of FIGS. 1 and 2 in absence of the user.

FIG. 4 is a perspective sectional view of a casing of the earpiece headset assembly of FIGS. 1-3.

FIG. 5 is a front view of the user of FIGS. 1 and 2 wearing an alternate embodiment of an earpiece headset assembly in the form of separately disposed earpieces at each of the user's ears.

### DETAILED DESCRIPTION

Embodiments are described with reference to certain earpiece headset assemblies having wireless features. These may include dual speaker embodiments akin to traditional headsets or single ear earpiece assemblies which may employed singularly or two at a time, reminiscent of a pair of earrings. In the dual speaker embodiment or when utilized as an earring pair type of embodiment, stereo quality sound may be provided. Regardless, due to the ergonomic displacement of a bulky casing accommodating the majority of the assembly components, the embodiments described herein may be particularly useful for long-term and/or everyday wear.

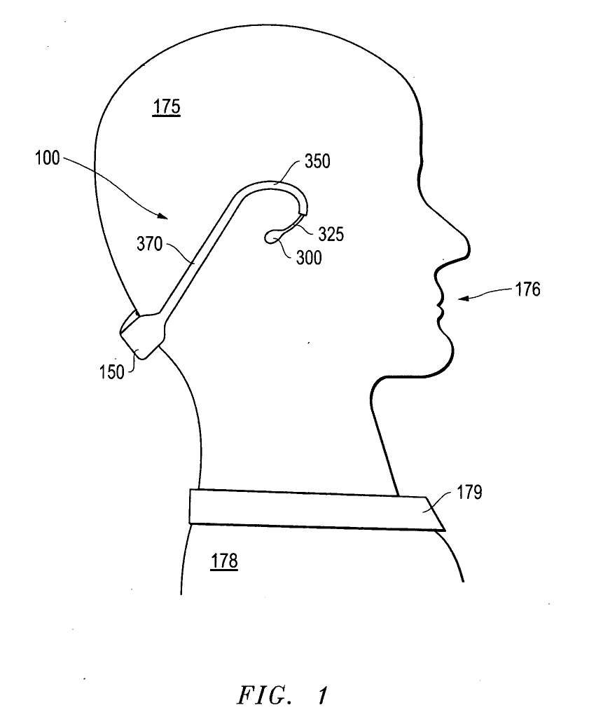

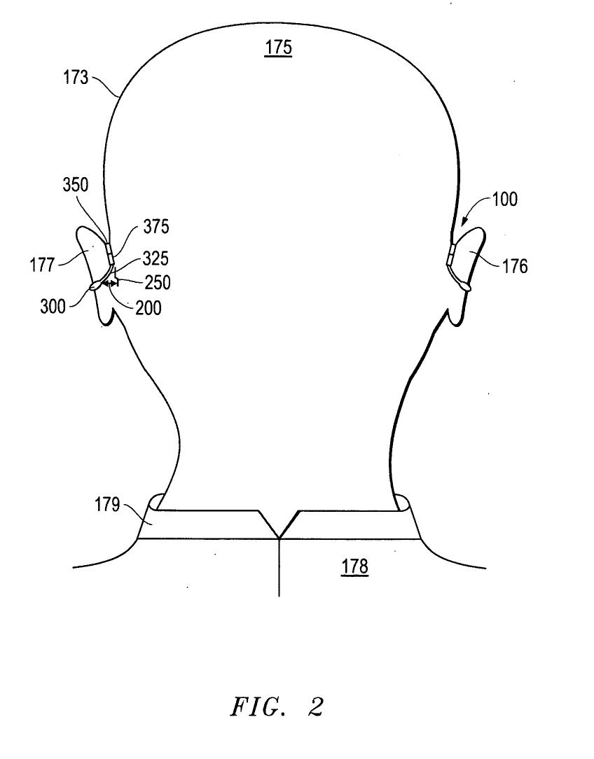

Referring now to FIGS. 1 and 2, side and front views of an embodiment of an earpiece headset assembly 100 are depicted as worn by a user 175. This embodiment wraps from ear 176 to ear 177 around the back of the user's head 173. A casing 150 is provided which rests near and above a neckline of the user 175. That is to say, for the depictions of FIGS. 1 and 2, the casing 150 is suspended from the ears 176, 177, by a casing support 370, into the direction of a collar 179 of a shirt 178. Thus, given the bulk of the casing 150 as detailed further below, this suspended displacement may enhance user comfort for long term wear of the assembly 100.

In one embodiment, the assembly 100 is configured for wireless transmission such as by conventional infrared, radio frequency (RF) and/or Bluetooth protocols. As detailed further below, components for supporting such transmissions may be housed within the casing 150. Alternatively, in another embodiment, the assembly 100 may be utilized as an aid to hearing of the user 175. Again, in such an embodiment, supportive components may be housed within the casing 150. Additionally, conventional piezo-electric and/or bone conducting hearing aid or enhancing components may also be disposed in an ear support 350 of the assembly 100 as also described further below.

Continuing with reference to FIGS. 1 and 2, the noted casing supports 370 of the assembly 100 are coupled to ear supports 350 which serve to anchor the above-noted suspended displacement from the ears 176, 177. That is, the ear supports 350 are configured to fit around each ear 176, 177 in a hook-like manner. Thus, the weight of the assembly 100 is supportively shared by the ears 176, 177. More specifically, the forces imparted on the ears 176, 177 due to the weight of the casing 150 and overall assembly 100 are distributed across the ear supports 350 and ears 176, 177. Thus, user comfort is enhanced, particularly where long term wear of the assembly 100 is to be employed.

The enhanced user comfort is largely due to the slim elongated nature of the ear supports 350. In one embodiment the supports 350 may be no wider than about 0.25 inches but may extend to more than about two inches in terms of the hook-like contact across the back of the ears 176, 177 (e.g. at the location between the main body of the ear 176, 177 and the side of the user's head 173). As a result, the noted assembly weight is transitioningly distributed across extended areas of multiple ears 176, 177 while simultaneously minimizing the overall amount of actual contact between the assembly 100 and the user's ears 176, 177. This is in sharp contrast to conventional assemblies. Such assemblies may employ large bulky casings uncomfortably wedged between the user's ears 176, 177 and the side of the user's head 173. Alternatively, such conventional assemblies may employ such casings and/or speakers cumbersomely positioned at the outside of the user's ear 176, 177, generally uncomfortably blocking the user's entire ear (and hampering hearing ability of the user when the assembly is not in use).

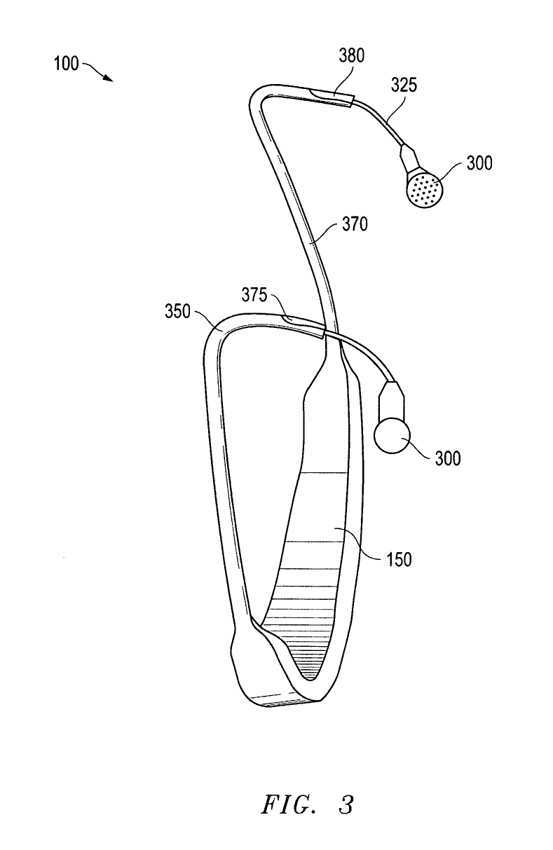

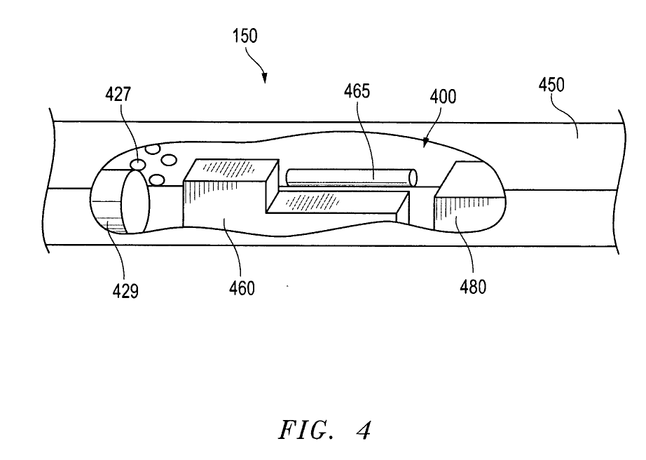

The assembly 100 further accommodates speaker supports 325 with speakers 300 disposed for delivery of sound to the ears 176, 177 of the user 175. The speaker supports 325 are physically coupled to the casing 150, described above, via casing supports 370 (see FIG. 3). The casing supports 370 are low profile extensions, perhaps less than about 0.25 inches in width like the ear supports 350. However, in some cases, the casing supports 370 may be of a greater profile than the ear supports 350. Regardless, the casing supports 370 serve to displace the bulk of the casing 150 while also allowing for communication between the speaker 300 and components 400 within the casing 150 as described further herein (see FIG. 4).

The length of the casing supports 370 may depend on user preference for the particular elevation or locating of the casing 150 at or above the neckline as depicted. However, an even larger factor in determining the length of the casing supports 370 may be the size of the user's head 175. For example, casing supports 370 of less than about 5.0 inches in length should more than accommodate a wrap-around of the assembly 100 about the user's head 175 as depicted. The assembly 100 may also be made available with a variety of different head sizing in mind, including child sizes. Such sizing may be largely determined by the size of the casing supports 370 and/or the ear supports 350. Indeed, in one embodiment both such supports 370, 350 may be adjustable or interchangeable with supports 350, 370 of different sizing.

The casing supports 370 described above are coupled to the casing 150 and ear supports 350 by conventional means. In order to provide electrical conductivity, the casing supports 370 may include electrically conductive cores. For example, in one embodiment, the casing supports 370 may include dual conductor wiring akin to conventional speaker wiring. In one embodiment, the casing 150 may suspend loosely from the ear supports 350 by way of a pliant or loosely conforming casing supports 370. However, in other embodiments a more rigid form of casing supports 370 may be desirable. Whether loose or rigid, the casing supports 370 displace the casing 150 to a location behind the user's head 175 roughly opposite the user's mouth 176. Thus, a focused microphone such as an array microphone 429 may be incorporated into the casing 150 to compensate for this general lack of proximity and thereby enhance audio reception thereat (see also FIG. 4).

Addressing user comfort as described above, by displacement of the bulk of the casing 150, is achieved in a manner employing negligible, if any, actual wiring, in the conventional sense. That is, the assembly 100 includes no wiring beyond what may be present between the speakers 300 and the casing 150. The configuration of the assembly 100 is unitary with no cumbersome wiring to interfere with the user's natural hand or body movements. There is no wiring even present within the user's own line of sight. However, to the extent that portions of the assembly 100, such as the casing 150, may be visible to others, size, shape, color, and other characteristics may be employed dependent on the aesthetic preferences of the user 175.

Referring now to FIGS. 2 and 3, features of the assembly 100 closer to the ears 176, 177 are described in greater detail. In the embodiment shown, the noted ear supports 350 wrap around and behind the ears 176, 177 of the user 175, keeping the entire assembly 100 stabilized. The ear support 350 may be of a conventional plastic or polymer material, including fluoropolymers and polymer foams. In fact, any compatible material having both stable and somewhat flexible physical characteristics for placement and use as shown in FIG. 2 may be employed.

As noted, the ear support 350 described above may have a width of less than about 0.25 inches, providing a comfortable fit between an ear 176, 177 and the head 173 of a typical user 175. Additionally, the overall size of the ear support 350 may be determined according to common ear sizes. For example, measuring in a diameter-like fashion, the ear supports 350 may be between about 2.0 inches and about 2.5 inches across their widest portions or 3 to 4 inches circumferentially. However, other sizes may be made available.

The ear supports 350 are stably supported by the ears 176, 177 when in place for use (see FIGS. 1 and 2). Therefore, at least one of the ear supports 350 may be a good candidate location for accommodating an actuator 375 as shown, which may be physically manipulated by the user 175. In fact, the actuator 375 may be located at the front of the ear support 350 as this location is both easily manually accessible to the user 175 and stably supported by the ear 177. Additionally, this or another user interface actuator may be located at an outer surface of the casing 150 which may be a good candidate location for powering up or down of the device before or after wear by the user 175.

In one embodiment, the actuator 375 described above is a button for physical manipulation by the user 175. For example, when the assembly 100 is paired to a cell phone, the user 175 may press the actuator 375 to achieve communication with a microprocessor 460 shown in FIG. 4 to direct acceptance of an incoming phone call over the wireless earpiece assembly 100 from the cell phone. Additionally, with multiple ear supports 350 available, another actuator 380 may similarly be located at the alternate support as shown in FIG. 3, for example to serve as a power or other channel switching button.

A light emitting diode (LED) may further be incorporated into the assembly 100, for example at the casing 150, an ear support 350 or other supportive structure. Such an LED may be employed to visually indicate an incoming call, pairing with a cell phone, or provide other indications (e.g. when the wireless earpiece assembly 100 is near the user and not being worn). In one embodiment, the actuator 375, 380 may actually be LED buttons. In another embodiment, the actuators 375, 380 may be motion detectors, light sensors, or other electronic readers to enhance the stability of the entire wireless earpiece assembly 100 during use by allowing physical manipulation thereof by the user 175 to be achieved by a mere manual touching or covering of the actuator 375, 380.

The above noted speaker supports 325 may be dual conductor wiring with a configuration akin to conventional speaker wiring. In this manner, the speaker 300 may be conductively employed by conventional means. However, in the embodiment shown, the speaker supports 325 are also configured to support the speaker 300 with a separation 200 as described further below. Therefore, the speaker supports 325 may be of heavy gauge wiring configured to retain a manually user-defined shape. That is, the speaker supports 325 may be conformed to a stable and naturally retainable configuration by a user 175 as shown in FIG. 2.

In order to achieve both conductivity and stable conformation, embodiments of speaker supports 325 may include between about 8 and about 20 gauge dual conductor metal wiring, most preferably of copper. However, the particular gauge, overall dimensions, and materials selected for the speaker supports 325 will be based in part on the weight of the supported speakers 300. For example, in one embodiment, the speaker supports 325 may include 16-18 gauge dual copper wiring, with each line independently insulated with up to about 15 mils of a polyethylene, nylon, or other conventional insulating jacket. Such speaker supports 325 would reliably and stably support conventional earpiece speakers 300 of at least about 0.25 ounces. Additionally, in this embodiment, the speaker supports 325 would be no wider across, in diameter or otherwise, than about 0.2 inches, well sized for coupling to closely sized conventional wiring or other conducting means through the ear supports 350 and to the casing supports 370.

Referring specifically to FIG. 2, the stability and compliant nature of the speaker supports 325 are shown in the user-defined separation 200 that is formed and stably maintained between the speakers 300 and adjacent ear surfaces 250. The speakers 300 are shown positioned in line with an auditory canal of the user 175. As described above, the separations 200 may be a result of the user 175 manually shaping the speaker supports 325 to the conformation shown based on the user's own personal preference and comfort. Thus, the user 175 is able to keep the speakers 300 off of the ear 176, 177 and ear surface 250 allowing for greater user comfort, especially where the user 175 employs the assembly 100 for an extended period of time.

The above-noted separations 200 may be anywhere up to about 0.5 inches depending on the comfort or preference of the user 175. The separations 200 also allow the ears 176, 177 and auditory canal of the user 175 to remain open and unblocked for hearing other sound when the assembly 100 is in place but not in use. Therefore, the assembly 100 need not be removed and replaced continuously in order to facilitate good hearing of sound emanating from outside the speakers 300. Furthermore, the stable nature or heavy gauge of the speaker supports 325 allows them to retain their shape once conformed thereto by the user 175. Thus, the user 175 also need not continually shape and position the speaker supports 325 upon each use of the assembly 100.

Given the presence of a separations 200 as described above, the speakers 300 employed may be directional in nature. That is, the speakers 300 may employ available and evolving hypersonic sound (HSS) capacity in order to focus or direct sound to the auditory canal of the user 175. In this way, the sound transferred from the speakers 300 is focused across the separation 200, specifically to the user 175. Thus, the separations 200, provided for the comfort of the user 175 are not achieved at the expense of maintaining quality and personal integrity of the sound transferred from the speakers 300 to the user 175. Rather, employing hypersonic sound (HSS) capacity in the speaker 300 delivers quality sound to the user 175 and prevents others nearby from overhearing or being distracted by the sound emanating from the speakers 300.

Referring now to FIGS. 2 and 4, the casing 150 is described in further detail. In the embodiment shown, the casing 150 with components 400 therein, includes a significant portion of the bulk or volume of the entire earpiece headset assembly 100, perhaps more than about half. Therefore, in the embodiment shown, most of the bulk of the wireless earpiece assembly 100 is maintained at a user-friendly location avoiding discomfort to the user 175 therefrom.

With particular attention to FIG. 4, the casing 150 includes an outer shell 450 configured to house several components 400 of the assembly 100. In the embodiment shown, the casing 150 includes a microprocessor 460 coupled to other components 400 of the casing 150 for directing interaction therebetween. The casing 150 further includes a microphone 429 resting adjacent sound inlets 427. Another component in the form of a data storage card, chip or other suitable memory device may also be housed within the casing 150. So, for example, where the assembly 100 is to be employed as a sound player, such as a conventional MP3 or other digital audio player, such functionality may be supported.

Additional components 400 of the casing 150 shown in FIG. 4, include a conventional transceiver and antenna assembly 465. This assembly 465 may include separate and discrete receiver, transmitter and antenna components or such components may be more integral with one another as a conventional transceiver. A self-contained power source 480 is also housed in the shell 450 of the casing 150. The power source 480 is self-contained in that it need not be hard wired to a larger immobile source of power in order to provide power to the assembly 100 and components 400 thereof. In one embodiment, the power source 480 is a conventional rechargeable lithium ion battery configured for mobile housing within the casing 150 as indicated. Similarly, the more additional components 400 accommodated by the casing 150, the less the overall bulk of the assembly 100 that must be borne at the ear 176, 177 of the user 175.

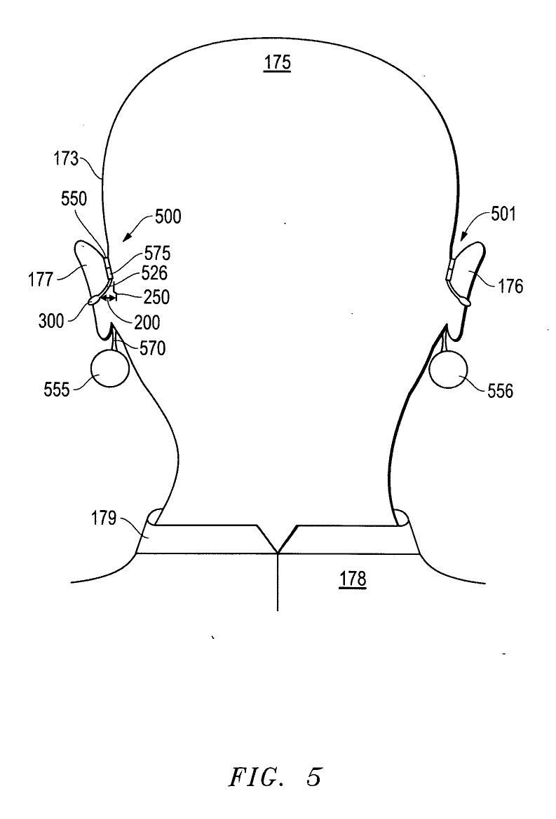

Referring now to FIG. 5, a front view of the user 175 of FIGS. 1 and 2 is depicted wearing an alternate embodiment of an earpiece headset assembly in the form of separately disposed earpieces 500, 501 at each of the user's ears 176, 177. While differing in appearance from the assembly 100 of FIGS. 1-4, the earpieces 500, 501 of FIG. 5 are distinguished only by the duplicating of the casing 150 of FIGS. 1-4 into separate casings 555, 556. That is to say, separate casings 555, 556 accommodating different sets of electronic components as described hereinabove may be independently provided to each of the earpieces 500, 501, whereas in the embodiments of FIGS. 1-4, a single shared casing 150 with components therein was utilized.

Indeed, each earpiece 500, 501 is still outfitted with its own speaker 300 and speaker support 526 capable of supporting a user defined separation 200 away from the user's adjacent ear surface 250. Each earpiece 500, 501 may include its own ear support 550 which slimly and comfortably transitions across the back of the user's ear 176, 177. The ear supports 550 may accommodate actuators 575 and eventually couple to casing supports 570 as also detailed with respect to the embodiments of FIGS. 1-4. Thus, the separate casings 555, 556 may be comfortably accommodated in the same manner as the casing 150 of FIGS. 1-4. Thus, long term everyday wear of the earpieces 500, 501 is now also a comfortably viable option for the user 175.

Embodiments described above provide headset assemblies 100 (or 500 and 501) configured to minimize the uncomfortable effects of bulk and potentially weight to a user employing such an assembly, especially during long term wear. These headsets may serve as an aid to hearing of a user. Additionally, these embodiments may also simultaneously optimize the user-friendly, hands-free and non-cumbersome advantages afforded by wireless technology, for example, by remaining completely free of potentially cumbersome wiring or alternatively employing no more than a minimal total wiring that is positioned out of the way of the user.

Although exemplary embodiments describe particular earpiece headset assemblies for pairing to certain types of mobile devices such as cell phones or smartphones, additional embodiments are possible. For example, the assemblies may be configured for wirelessly coupling or pairing to a host of other devices, such as radios or other audio devices. Additionally, for sake of discussion, the assemblies are generally described in terms of different supports such as an ear support, casing support, and/or speaker support. However, description of such supports in this manner is merely illustrative of different general regions of the assemblies. So, for example, a casing support may smoothly transition into an ear support which may similarly transition into an ear support in a smooth manner without any discrete demarcation noticeable between the noted supports. That is to say, the supports may be fashioned together into a single unitary form factor configuration without departing from the spirit and scope of the embodiments detailed herein. Similarly, many other changes, modifications, and substitutions may be made without departing from the spirit and scope of the described embodiments.

I claim:

1. An earpiece headset assembly comprising:
an ear support having a portion for positioning a speaker at a user's ear:
a casing coupling to a portion of said ear support and of a bulk for accommodating a plurality of electronic components of the assembly, one of the components being a self-contained mobile power source; and
a casing support to provide the coupling and to displace the bulk of said casing to a location between the user's ear and a neckline of the user.

2. The assembly of claim 1 wherein the speaker serves as an aid to hearing by the user.

3. The assembly of claim 1 wherein said casing support is a first casing support and said ear support is a first ear support accommodating the portion for positioning the speaker at one of the user's ears, the assembly further comprising:
a second ear support having another portion for positioning another speaker at the other ear of the user; and
a second casing support coupled to said casing and said second ear support to displace the bulk thereof to the location between the user's other ear and the neckline.

4. The assembly of claim 3 wherein the speakers are equipped with hypersonic sound delivery capacity.

5. The assembly of claim 3 wherein the components are selected from a group consisting of a visible light source, a data storage device, a transceiver, a transmitter, a receiver, an antenna, a microprocessor, and a microphone.

6. The assembly of claim 5 wherein the transceiver, transmitter, receiver and antenna are configured for use over a wireless Bluetooth platform.

7. The assembly of claim 3 wherein each said ear support occupies less than about 0.25 inches of width between a given one of the ears and a corresponding side of the user's head.

8. The assembly of claim 3 wherein said casing supports are each between about 0.25 inches and about 5.0 inches in length.

9. The assembly of claim 3 wherein said casing supports are of a pliant conformation for loosely suspending said casing from said ear support.

10. The assembly of claim 3 wherein said casing supports are of a stable conformation for supporting said casing in a semi-lateral direction toward the neckline.

11. The assembly of claim 3 wherein at least one of said ear supports further accommodates an actuator to serve as a controlling interface for the user relative the assembly.

12. An earpiece headset assembly comprising:
a first ear support for positioning behind a user's first ear and securing thereat;
a first speaker coupling to said first ear support and configured for delivering sound to the user's first ear;
a second ear support for positioning behind a user's second ear and securing thereat;
a second speaker coupling to said second ear support and configured for delivering sound to the user's second ear; and
conformable elongated speaker supports extending from said ear supports to said speakers for the couplings therebetween, said speaker supports configured to maintain a user-defined separation between each said speaker and the corresponding ear.

13. The assembly of claim 12 wherein each said speaker is equipped with hypersonic sound delivery capacity to direct the sound across the separations to each respective ear of the user during the delivering.

14. The assembly of claim 12 wherein the separations are up to about 0.5 inches.

15. The assembly of claim 12 wherein each said ear support is configured to occupy less than about 0.25 inches of width between a given one of the ears and a corresponding side of the user's head.

16. The assembly of claim 12 further comprising:
a casing of a bulk for accommodating a plurality of electronic components;
a first casing support coupled to said casing and to said first ear support; and
a second casing support coupled to said casing and to said second ear support, said casing supports serving to displace the bulk to a location between the ears and a neckline of the user.

17. The assembly of claim 12 wherein the components include components providing wireless Bluetooth capacity to the assembly.

18. An audio assembly comprising:
first and second supports having portions configured for securing at locations of a user's ears and for directing sound to the ears; and
a casing of a bulk exceeding said supports and coupled thereto for displacement to a location adjacent a back of a neck of the user, said casing configured to accommodate a mobile power source and electronic components to process and transmit audio signals for the directing.

19. The assembly of claim 18 further comprising speakers for the directing, said speakers equipped with hypersonic sound delivery capacity.

20. The assembly of claim 18 wherein said casing is configured to further accommodate one of a visible light source, a microphone, a data storage device and a user interface actuator at an outer surface thereof.
